(19) United States
(12) Patent Application Publication
(10) Pub. No.: US 2026/0005519 A1
(43) Pub. Date: Jan. 1, 2026

(54) Software Architecture and System for Delivering Selected Performance Management Protocols for Zero Emission Electrical Generators

(71) Applicant: BWR Innovations LLC, West Fargo, ND (US)

(72) Inventors: Sean K. Frederick, New Braunfels, TX (US); Adam C. Jorgenson, West Fargo, ND (US); Joel A. Jorgenson, West Fargo, ND (US)

(21) Appl. No.: 19/256,307

(22) Filed: Jul. 1, 2025

Related U.S. Application Data
(60) Provisional application No. 63/666,364, filed on Jul. 1, 2024.

(51) Int. Cl. H02J 3/46; H02J 13/00

(52) U.S. Cl. CPC H02J 3/46; H02J 13/00002

(57) ABSTRACT

A zero-emission generator system comprises hydrogen fuel cell modules, electrolyzers, energy storage components, and a cloud-based telemetry system for autonomous operational control. The system receives electrical power from renewable sources and grid connections, with excess energy directed to electrolyzers for hydrogen production and storage in compressed form. A control system interfaces with cloud-based processing algorithms that analyze real-time utility pricing, renewable energy availability, storage levels, and market conditions to select optimal operational protocols. Four distinct protocols enable cost optimization, renewable energy maximization, storage maximization, and revenue generation through energy sales and grid services. The cloud-based system processes external data including utility rate structures, weather forecasting, and energy market pricing to generate operational commands transmitted to local control systems. Protocol selection occurs autonomously based on user preferences and real-time conditions, enabling proportional or absolute energy source allocation to supply electrical loads. The system coordinates electrical storage in batteries with chemical storage as compressed hydrogen, providing extended operational duration and grid independence while optimizing economic performance through intelligent energy source management and market participation capabilities.

### CROSS REFERENCE TO RELATED APPLICATIONS

I hereby claim benefit under Title 35, United States Code, Section 119(e) of United States, provisional patent application Ser. No. 63/666,364 filed Jul. 1, 2024 (Docket No. JORG-073). The 63/666,364 application is currently pending. The 63/666,364 application is hereby incorporated by reference into this application.

### STATEMENT REGARDING FEDERALLY SPONSORED RESEARCH OR DEVELOPMENT

Not applicable to this application.

### BACKGROUND

Example embodiments in general relate to a software architecture and system for delivering selected performance management protocols for zero emission generators used for primary power, secondary or backup power, or emergency services.

### SUMMARY

According to some embodiments, the present disclosure is directed to a system for managing performance protocols in a zero-emission electrical generator. The system also includes a zero-emission generator comprising a hydrogen fuel cell module, an electrolyzer, a hydrogen storage tank, an energy storage device, and an inverter configured to receive power from a plurality of energy sources including grid power, renewable power sources, and power from the hydrogen fuel cell module. The system also includes a cloud-based telemetry system comprising a processor and memory, the cloud-based telemetry system configured to store a plurality of user-selectable performance management protocols, each performance management protocol defining operational parameters for generator performance according to different objectives.

The system also includes a user interface operatively connected to the cloud-based telemetry system and configured to receive user inputs. The system also includes a communication interface configured to establish bidirectional communication between the zero-emission generator and the cloud-based telemetry system.

In some instances, the cloud-based telemetry system is configured to: receive real-time operational data from the zero-emission generator via the communication interface, receive a protocol selection input from the user interface and identify a corresponding performance management protocol from the plurality of user-selectable performance management protocols, automatically generate control commands based on the corresponding performance management protocol and the real-time operational data, and transmit the control commands to the zero-emission generator via the communication interface to automatically control energy source selection and proportioning without manual user intervention at the generator. Other embodiments of this aspect include corresponding computer systems, apparatus, and computer programs recorded on one or more computer storage devices, each configured to perform the actions of the methods.

Implementations may include one or more of the following features. The plurality of user-selectable performance management protocols may include a lowest cost protocol configured to minimize operational costs by selecting energy sources based on real-time cost comparisons between grid electricity, energy stored in the energy storage device, and energy stored in the hydrogen storage tank.

The plurality of user-selectable performance management protocols may include a maximum renewable protocol configured to prioritize renewable energy sources and redirect renewable energy exceeding load demand to the energy storage device and the hydrogen storage tank. The plurality of user-selectable performance management protocols may include a maximum storage protocol configured to charge the energy storage device and the hydrogen storage tank to their respective storage capacities.

The plurality of user-selectable performance management protocols may include a maximum revenue protocol configured to sell stored electrical energy and stored hydrogen based on market pricing data. The cloud-based telemetry system configured to receive grid pricing data may include time-of-day rates, demand charges, and peak usage charges for use in generating the control commands. The control commands may include proportional allocation commands specifying percentages of power to be delivered from each of the plurality of energy sources.

The control commands may include absolute allocation commands specifying maximum power amounts to be delivered from each of the plurality of energy sources. The zero-emission generator may include a compressor configured to compress hydrogen from the electrolyzer for storage in the hydrogen storage tank.

According to some embodiments, the present disclosure includes a method of operating a zero-emission electrical generator having a plurality of energy sources, the method comprising establishing communication between the zero-emission generator and a cloud-based telemetry system; uploading real-time operational data from the zero-emission generator to the cloud-based telemetry system, wherein the operational data includes power generation levels, storage levels, and energy consumption data. The method can include receiving a user selection of a performance management protocol from a plurality of available protocols stored in the cloud-based telemetry system, each protocol defining different objectives for generator operation, and automatically determining energy source allocation based on the performance management protocol corresponding to the user selection and the real-time operational data.

The method can include generating control commands corresponding to the energy source allocation, and transmitting the control commands from the cloud-based telemetry system to the zero-emission generator to automatically control energy distribution from the plurality of energy sources comprising grid power, renewable power sources, and hydrogen fuel cell power. Implementations of the described techniques may include hardware, a method or process, or computer software on a computer-accessible medium.

Another general aspect includes a method of managing performance protocols for zero-emission electrical generators. The method also includes storing a plurality of performance management protocols in a cloud-based telemetry system, each protocol comprising operational parameters for achieving different performance objectives. The method also includes providing a user interface operatively connected to the cloud-based telemetry system for selecting from the plurality of performance management protocols.

The method also includes receiving real-time data from a zero-emission generator comprising hydrogen production rates, hydrogen storage levels, electrical storage levels, renewable energy availability, and grid power costs. The method also includes processing the real-time data in combination with a selected performance management protocol to determine operational settings for the zero-emission generator.

The method also includes automatically generating control signals based on the operational settings. The method also includes transmitting the control signals to the zero-emission generator to implement automatic energy source management according to the selected performance management protocol. Other embodiments of this aspect include corresponding computer systems, apparatus, and computer programs recorded on one or more computer storage devices, each configured to perform the actions of the methods.

Implementations may include one or more of the following features. The method wherein the plurality of performance management protocols may include a maximum storage protocol configured to simultaneously charge energy storage devices and produce hydrogen for storage when renewable energy exceeds load demand.

The method wherein the processing may include accessing external data sources including real-time electricity pricing, renewable energy forecasts, and market pricing for stored energy products. The method wherein the operational settings may include energy source priorities, storage charging rates, and load distribution ratios among a plurality of energy sources. The method may include monitoring performance of the selected performance management protocol and automatically adjusting the operational parameters based on measured performance metrics.

The method wherein the determining energy source allocation may include comparing real-time costs of grid electricity with calculated costs of generating electricity from stored hydrogen and electrical energy stored in the energy storage device. The method wherein the performance management protocol may include a lowest cost protocol, and the determining energy source allocation may include selecting renewable energy sources when available at no cost and comparing costs of energy from storage devices with grid electricity costs.

The method wherein the performance management protocol may include a carbon footprint minimization protocol, and the determining energy source allocation may include prioritizing renewable energy sources and selecting between grid power and stored energy based on carbon emissions data for each energy source. The method may include storing renewable energy exceeding load demand by directing surplus renewable power to the electrolyzer for hydrogen production or to the energy storage device. The method wherein the control commands may include instructions for proportional power distribution specifying percentages of total load demand to be satisfied by each energy source. Implementations of the described techniques may include hardware, a method or process, or computer software on a computer-accessible medium.

There has thus been outlined, rather broadly, some of the embodiments of the present disclosure in order that the detailed description thereof may be better understood, and in order that the present contribution to the art may be better appreciated. There are additional embodiments that will be described hereinafter and that will form the subject matter of the claims appended hereto. In this respect, before explaining at least one embodiment in detail, it is to be understood that the various embodiments are not limited in its application to the details of construction or to the arrangements of the components set forth in the following description or illustrated in the drawings. Also, it is to be understood that the phraseology and terminology employed herein are for the purpose of the description and should not be regarded as limiting.

To better understand the nature and advantages of the present disclosure, reference should be made to the following description and the accompanying figures. It is to be understood, however, that each of the figures is provided for the purpose of illustration only and is not intended as a definition of the limits of the scope of the present disclosure. Also, as a general rule, and unless it is evidence to the contrary from the description, where elements in different figures use identical reference numbers, the elements are generally either identical or at least similar in function or purpose.

### BRIEF DESCRIPTION OF THE DRAWINGS

FIG. 1 is a schematic view of a system showing a zero-emission generator, external energy sources, load, and interconnections.

FIG. 2 is a block diagram illustrating the communication architecture and bidirectional data exchange between the generator and cloud-based control system.

FIG. 3 is a data flow diagram depicting information exchange pathways and communication between system components.

FIG. 4 is a decision tree showing how the system autonomously chooses between different operational protocols.

FIG. 5 is a flowchart illustrating real-time decision-making for optimal power source allocation.

FIG. 6 is a timeline diagram showing system management throughout a twenty-four hour cycle.

FIG. 7 is a process flow diagram demonstrating market participation and income optimization strategies.

FIG. 8 is a decision matrix coordinating electrical and hydrogen energy storage systems.

### DETAILED DESCRIPTION

### A. Overview

Existing zero-emission generator control systems suffer from significant limitations that prevent effective optimization of multi-source electrical generation systems. Conventional inverter control systems require direct user input through limited time-of-use panels with restricted programming capabilities, making real-time optimization based on complex utility rate structures impractical. Known systems lack integration with external data sources necessary for informed decision-making, such as real-time grid pricing information, demand charge calculations, and renewable energy availability forecasting. Furthermore, conventional systems do not provide coordinated control between hydrogen production via electrolysis, multiple energy storage modalities, and dynamic source selection based on economic and environmental optimization criteria.

Current fuel cell generator systems operate as isolated units without cloud-based computational capabilities, limiting their ability to process the complex algorithms required for multi-variable optimization. Known approaches fail to address the technical challenge of coordinating renewable energy curtailment management with hydrogen production and storage, resulting in wasted renewable energy resources. Additionally, existing systems lack the capability to participate in energy markets or provide grid services, limiting their economic utility and failing to address the growing need for distributed energy resources that can provide ancillary services to the electrical grid.

The present disclosure introduces a software architecture comprising four distinct operational protocols that can be selected through high-level user preferences and automatically translated into specific operational parameters by cloud-based processing algorithms. The Cost Optimization Protocol incorporates real-time utility rate analysis, including time-of-day pricing, demand charges based on peak consumption measurement intervals, and volumetric pricing variations, to determine optimal energy source selection at each operational decision point. The Renewable Maximization Protocol includes algorithms for managing renewable energy curtailment by automatically redirecting excess production to electrolysis systems for hydrogen generation, thereby converting otherwise wasted renewable energy into storable chemical energy.

The Storage Maximization Protocol coordinates both electrical energy storage systems and compressed hydrogen storage to optimize total system energy storage capacity and duration. This protocol includes charge management algorithms that balance charging rates between energy storage devices and hydrogen production systems based on storage capacity, round-trip efficiency considerations, and economic optimization criteria. The Revenue Maximization Protocol incorporates market participation algorithms that analyze spot energy pricing, virtual power plant participation opportunities, and hydrogen market pricing to determine optimal timing for energy sales versus local consumption.

The present disclosure implements a cloud-based processing architecture that receives telemetry data from the zero-emission generator including performance metrics, energy production and consumption measurements, storage system status, and operational parameters. External data integration capabilities include real-time utility pricing feeds, weather and renewable energy forecasting data, and energy market pricing information. The cloud-based system processes this combined data through optimization algorithms that determine optimal operational parameters and transmit control commands to the generator control system via bidirectional communication links.

The computational architecture enables processing of complex optimization problems that exceed the capabilities of edge-based control systems typically employed in generator applications. Algorithm execution includes multi-variable optimization considering economic factors, environmental impact metrics, system efficiency parameters, and user-defined preferences. The system generates specific operational commands including energy source selection priorities, storage system charge and discharge parameters, grid synchronization settings, and hydrogen production rates.

The present disclosure provides coordinated control of renewable energy sources, grid connections, hydrogen fuel cell modules, electrical storage systems, and electrolysis equipment through a unified control interface. Energy source selection algorithms can operate in proportional mode, where specified percentages of total load demand are supplied by designated sources, or absolute mode, where maximum power limits are applied to sources in priority sequence until total demand is satisfied. Grid synchronization capabilities maintain voltage, frequency, and phase compatibility while enabling dynamic source selection based on optimization criteria.

The system includes hydrogen production management through integration with electrolysis systems that convert excess renewable energy into compressed hydrogen storage. Fuel cell module control enables conversion of stored hydrogen into electrical energy when determined optimal by the protocol algorithms. Battery storage integration provides electrical energy storage and discharge capabilities coordinated with hydrogen storage systems to optimize total system energy storage and discharge strategies.

The present disclosure incorporates market participation capabilities that enable the generator system to function as a distributed energy resource providing services to the electrical grid. Integration with virtual power plant networks allows participation in demand response programs and ancillary service markets. Real-time energy market analysis enables optimal timing of energy sales based on spot pricing and market conditions. Hydrogen market integration provides revenue generation through direct hydrogen sales via pipeline connections or portable storage vessel exchange programs.

The system includes algorithms for peak demand reduction services that monitor grid energy consumption and automatically supplement grid power with stored energy sources to reduce peak demand charges and provide grid support services. Market participation decisions are integrated with the operational protocol selection to ensure compatibility between user preferences and revenue generation activities.

The disclosed system represents a departure from conventional generator control approaches by integrating autonomous decision-making capabilities with multi-modal energy storage and market participation functions. The protocol-based architecture allows complex optimization strategies to be executed through simple user preference selections, eliminating the need for technical expertise in system operation. Cloud-based computational resources enable real-time processing of market data, utility rate structures, and system performance metrics to optimize operational parameters continuously.

The coordination of hydrogen production via electrolysis with renewable energy curtailment management addresses technical challenges not solved by existing systems. The ability to convert excess renewable energy into storable hydrogen creates a carbon-neutral energy storage mechanism that can be subsequently converted back to electricity or sold as a commodity. This dual-use capability for hydrogen as both an energy storage medium and a revenue-generating product distinguishes the invention from conventional battery-only storage approaches.

The integration of multiple energy storage modalities with intelligent protocol selection enables operation modes not achievable with conventional systems. The Revenue Maximization Protocol's capability to participate in energy markets while maintaining load supply reliability requires sophisticated algorithms that balance immediate energy needs with market opportunities. The system's ability to provide grid services through coordinated multi-source energy management creates additional revenue streams while supporting grid stability objectives.

### B. Example Embodiments

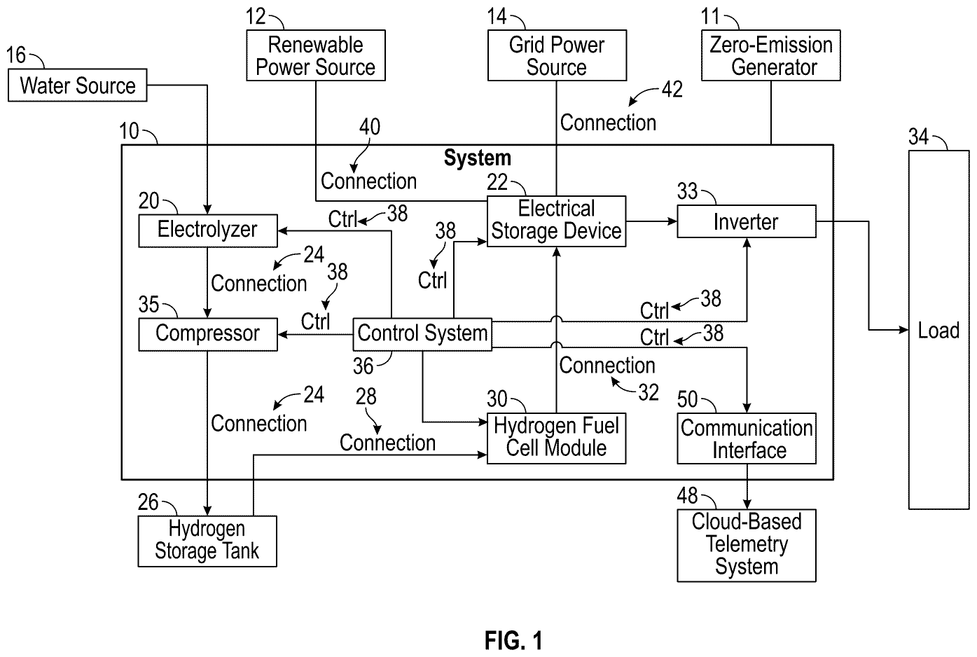

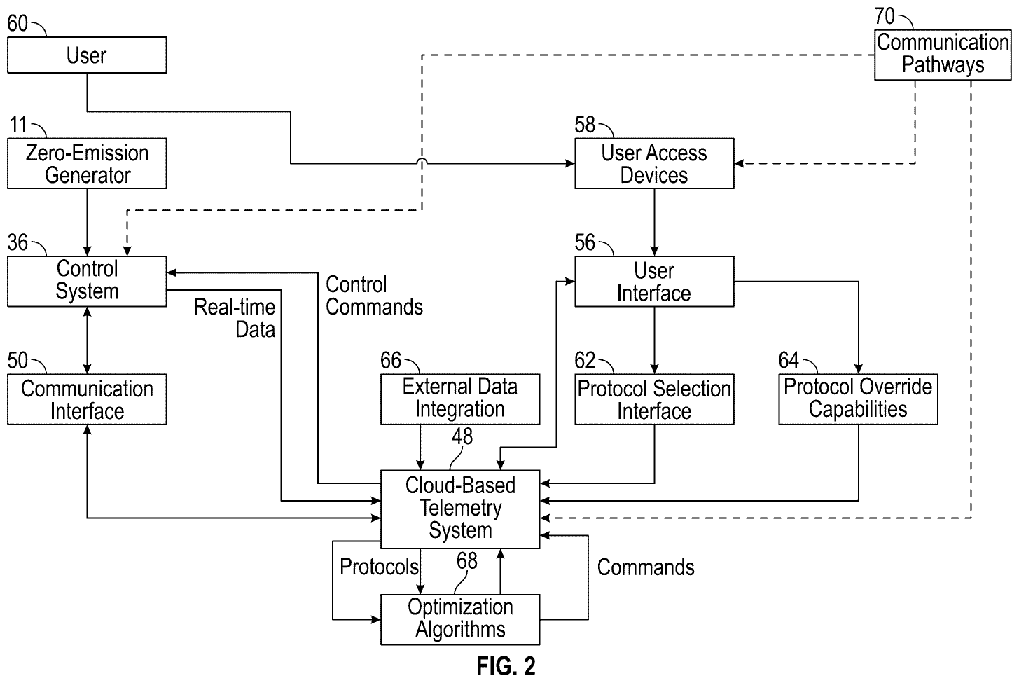

FIGS. 1 and 2 collectively illustrate a system 10 for managing performance protocols in a zero-emission electrical generator. The system 10 comprises a zero-emission generator 11, a cloud-based telemetry system 48, a user interface 56 operatively connected to the cloud-based telemetry system 48, and a communication interface 50 configured to establish bidirectional communication between the zero-emission generator 11 and the cloud-based telemetry system 48.

The zero-emission generator 11 comprises a hydrogen fuel cell module 30 positioned at a lower right portion of the system 10. The hydrogen fuel cell module 30 comprises electrochemical devices configured to convert hydrogen and oxygen into electrical energy without combustion or emissions. The hydrogen fuel cell module 30 receives feedstock hydrogen and combines it with atmospheric oxygen to produce DC (Direct Current) electricity through electrochemical processes.

The zero-emission generator 11 further comprises an electrolyzer 20 positioned centrally within the system 10. The electrolyzer 20 comprises electrochemical cells configured to decompose water from water source 16 into hydrogen and oxygen gases using electrical power received from either the renewable power source 12 or the grid power source 14. The electrolyzer 20 produces high purity hydrogen gas as primary output. A compressor 35 positioned between the electrolyzer 20 and the hydrogen storage tank 26 compresses the hydrogen gas from the electrolyzer 20 for efficient storage.

The zero-emission generator 11 includes a hydrogen storage tank 26. The hydrogen storage tank 26 comprises compression equipment and pressure vessels configured to receive compressed hydrogen from compressor 35 through hydrogen connection 24 and store compressed hydrogen in stable form. The hydrogen stored within hydrogen storage tank 26 remains stable over extended periods and supplies hydrogen fuel cell module 30 through hydrogen supply connection 28.

The zero-emission generator 11 comprises an energy storage device 22 positioned at a lower central portion of the system 10. The energy storage device 22 comprises battery storage components configured to store electrical energy and provide DC power output. The energy storage device 22 receives charging power from any one or more of renewable power source 12 through renewable power connection 40, from grid power source 14 through grid power connection 42, and/or from hydrogen fuel cell module 30 through electrical connection 32.

The zero-emission generator 11 further comprises an inverter 33 configured to receive power from a plurality of energy sources and convert DC electricity to AC (Alternating Current) electricity for supplying load 34. The plurality of energy sources includes grid power source 14, renewable power source 12 comprising photovoltaic solar panels or wind turbines, and power from hydrogen fuel cell module 30. The inverter 33 manages energy source selection and proportional allocation between the plurality of energy sources based on control commands received from control system 36. The inverter 33 receives DC power from energy storage device 22 and provides AC power output to load 34.

Control system 36 governs operation of components within the zero-emission generator 11 and may comprise a programmable logic controller (PLC), an industrial computer system, a microcontroller-based control unit, or a distributed control system. Control system 36 connects to electrolyzer 20, compressor 35, hydrogen storage tank 26, hydrogen fuel cell module 30, energy storage device 22, and inverter 33 through control connections 38. The control connections 38 may comprise wired communication protocols such as Modbus, CANbus, or Ethernet connections, wireless communication protocols such as WiFi or Zigbee, analog signal connections, or digital input/output connections. The control connections 38 enable the control system 36 to monitor operational parameters including temperature, pressure, voltage, current, and flow rates, and transmit control commands such as start/stop signals, setpoint adjustments, and operational mode selections to system components.

The communication interface 50 establishes bidirectional communication between the control system 36 and external systems, enabling remote monitoring and control capabilities for the zero-emission generator 11.

FIG. 2 illustrates the interaction between the control system 36 of the zero-emission generator 11 and the cloud-based telemetry system 48, enabling bidirectional data exchange and remote system management capabilities for the zero-emission generator 11 described in FIG. 1.

The control system 36 represents the local control infrastructure of the zero-emission generator 11 and comprises processing equipment, communication interfaces, sensors, and control circuitry configured to monitor and manage zero-emission generator 11 operations. The control system 36 continuously monitors performance parameters, operational status, and system conditions of all generator components including electrolyzer 20, hydrogen fuel cell module 30, hydrogen storage tank 26, energy storage device 22, and inverter 33.

The cloud-based telemetry system 48 comprises remote computational and data storage infrastructure including servers, databases, processing capabilities, and communication interfaces configured to receive, process, store, and analyze data from the zero-emission generator 11 installation. The cloud-based telemetry system 48 provides computational resources and data storage capacity that exceed the capabilities of local control systems and stores a plurality of user-selectable performance management protocols. Each performance management protocol defines operational parameters for generator performance according to different objectives including cost optimization protocols, renewable energy maximization protocols, storage maximization protocols, and revenue generation protocols.

The communication interface 50 establishes bidirectional communication between the control system 36 and the cloud-based telemetry system 48. The communication interface 50 enables both data upload from the control system 36 to the cloud-based telemetry system 48 and command download from the cloud-based telemetry system 48 to the control system 36. The communication interface 50 may comprise wired communication channels, wireless communication channels, or combinations thereof.

Data upload flows from the control system 36 to the cloud-based telemetry system 48 via the communication interface 50. The data upload includes information regarding performance, status, and operation of the zero-emission generator 11 collected by the control system 36. The performance information comprises energy production measurements, efficiency metrics, component operational parameters, and system output characteristics. The status information includes component health indicators, maintenance requirements, fault conditions, and system availability status. The operational information encompasses energy source selections, load demand patterns, storage system levels, and environmental conditions affecting the zero-emission generator 11 performance.

Command download flows from the cloud-based telemetry system 48 to the control system 36 via the communication interface 50. The command download includes user preferences, operational commands, protocol selections, and system configuration parameters determined by the cloud-based telemetry system 48. The cloud-based telemetry system 48 processes uploaded data, external information sources, and user inputs to generate optimized operational commands for transmission to the control system 36.

The user interface 56 connects to the cloud-based telemetry system 48 and enables user interaction with the zero-emission generator 11 system from remote locations. The user interface 56 comprises multiple access modalities that provide users with flexible connectivity options for monitoring and controlling the zero-emission generator 11 system.

User access devices 58 within the user interface 56 include tablet devices, mobile devices, laptop computers, desktop computers, and kiosk access terminals. The user access devices 58 provide interface capabilities enabling users to interact with the cloud-based telemetry system 48 from various locations and circumstances.

A user 60 represents the human operator who interfaces with the cloud-based telemetry system 48 through the user access devices 58. User 60 may access the cloud-based telemetry system 48 from any global position where communication connectivity is available. The cloud-based telemetry system 48 provides data regarding performance, economics, and status information to user 60 on demand.

Protocol selection interface 62 within the user interface 56 enables user 60 to select protocol preferences for zero-emission generator 11 operation. The protocol selection interface 62 provides access to cost optimization protocols, renewable maximization protocols, storage maximization protocols, and revenue maximization protocols. The protocol preferences selected by user 60 through protocol selection interface 62 are transmitted through the cloud-based telemetry system 48 to the control system 36 via command download.

Protocol override capabilities 64 within the user interface 56 may comprise emergency stop buttons, manual override switches, protocol suspension menus, or command line interfaces that provide user 60 with the ability to suspend or override automated protocol operations. The protocol override capabilities 64 may include an emergency stop button for immediate system shutdown, toggle switches for disabling specific automated functions, dropdown menus for selecting manual operational modes, or text input fields for entering direct operational commands. The protocol override capabilities 64 enable user 60 to interrupt automated protocol execution through actions such as clicking a “suspend automation” button, selecting “manual mode” from a control panel menu, or entering override commands through a command terminal interface to override specific operational decisions made by the cloud-based telemetry system 48.

External data integration 66 may comprise Application Programming Interfaces (APIs), web service connections, data feed subscriptions, or automated data retrieval systems that enable the cloud-based telemetry system 48 to process information sources beyond data received from the control system 36. The external data integration 66 may include Representational State Transfer (REST) API connections to utility company servers, eXtensible Markup Language (XML) data feeds from weather services such as National Oceanic and Atmospheric Administration (NOAA) or Weather Underground, WebSocket connections to energy market data providers such as Independent System Operator (ISO) grid operators, email-based demand response notifications from utility companies, or File Transfer Protocol (FTP) file transfers of regulatory updates from government databases. The external data integration 66 processes information including real-time utility pricing information received through secure HyperText Transfer Protocol Secure (HTTPS) connections, weather forecasting data retrieved via JavaScript Object Notation (JSON) API calls, energy market conditions accessed through financial data feeds, demand response signals transmitted via utility communication protocols such as Open Automated Demand Response (OpenADR), and regulatory information downloaded from government websites or received through automated email notifications.

Optimization algorithms 68 within the cloud-based telemetry system 48 analyze uploaded data, external information, and user preferences to generate operational commands. The optimization algorithms 68 implement computational processes that consider economic factors, environmental objectives, system efficiency parameters, and user-defined priorities. The optimization algorithms 68 generate specific operational commands including energy source selection priorities, storage charging and discharging parameters, grid interaction settings, and hydrogen production rates for transmission to the control system 36.

Communication pathways 70 provide the data transmission infrastructure enabling connectivity between the control system 36, cloud-based telemetry system 48, and user access devices 58. The communication pathways 70 may include internet connectivity, cellular networks, satellite communications, and other data transmission technologies.

The cloud-based telemetry system 48 is configured to receive real-time operational data from the zero-emission generator 11 via the communication interface 50. The real-time operational data includes performance measurements from hydrogen fuel cell module 30, operational status from electrolyzer 20, storage levels from hydrogen storage tank 26, charge status from energy storage device 22, and power flow data from the inverter 33 and energy source connections.

The cloud-based telemetry system 48 receives a protocol selection input from the user interface 56 and identifies a corresponding performance management protocol from the plurality of user-selectable performance management protocols. The cloud-based telemetry system 48 processes the protocol selection against current operational conditions and external data including utility pricing, renewable energy availability, and market conditions.

The cloud-based telemetry system 48 automatically generates control commands based on the corresponding performance management protocol and the real-time operational data. The control commands specify operational parameters for electrolyzer 20, hydrogen storage tank 26 management, hydrogen fuel cell module 30 output levels, energy storage device 22 charging and discharging, and inverter 33 energy source selection and proportioning strategies.

The cloud-based telemetry system 48 transmits the control commands to the zero-emission generator 11 via the communication interface 50 to automatically control energy source selection and proportioning without manual user intervention at the generator. Control system 36 receives the control commands and implements them through control connections 38 to coordinate operation of electrolyzer 20, hydrogen storage tank 26, hydrogen fuel cell module 30, energy storage device 22, and inverter 33 to optimize system performance according to the selected performance management protocol.

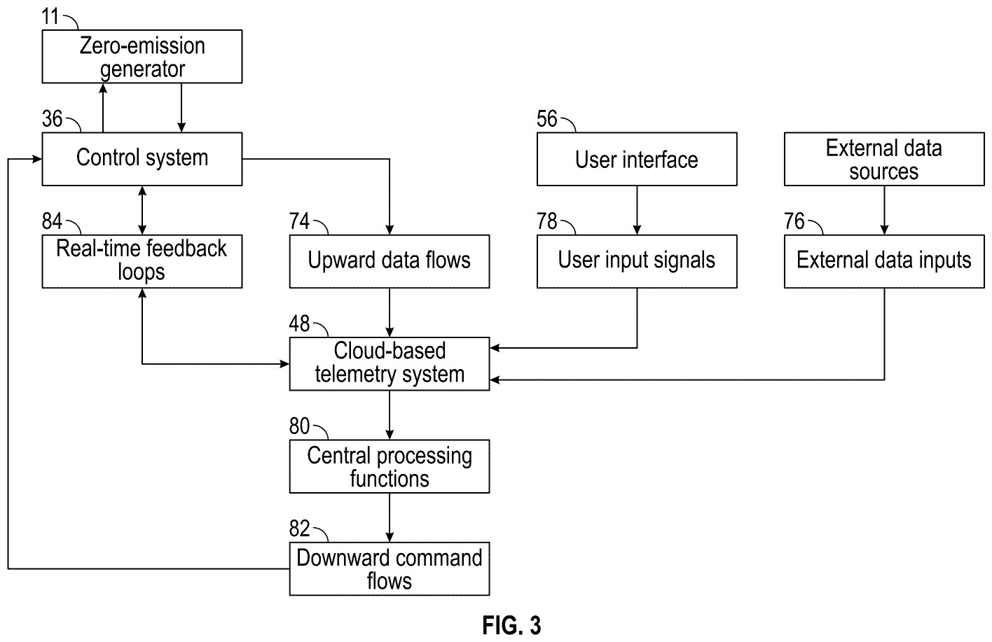

FIG. 3 illustrates data flows and information exchange pathways between the zero-emission generator 11, cloud-based telemetry system 48, external data sources, and user interface 56. The information that enables intelligent protocol selection and autonomous operational control of the zero-emission generator 11 system described in FIGS. 1 and 2.

Upward data flows 74 transmit information from the control system 36 to the cloud-based telemetry system 48. The upward data flows 74 include generator telemetry data comprising real-time measurements from electrolyzers, fuel cell modules, compressor and storage tanks, and batteries and inverters within the zero-emission generator 11 system. The upward data flows 74 further include operational status data encompassing component health indicators, maintenance requirements, fault conditions, and system availability information. Performance metrics data within the upward data flows 74 comprises efficiency measurements, energy conversion rates, storage levels, and operational capacity indicators. Energy production data transmitted through the upward data flows 74 includes electrical output measurements, hydrogen production rates, and renewable energy generation statistics collected by the control system 36.

External data inputs 76 flow into the cloud-based telemetry system 48 from sources independent of the zero-emission generator 11 system. The external data inputs 76 include real-time pricing feeds comprising time-of-day electrical rates, demand charge structures, peak pricing periods, and utility rate variations necessary for economic optimization calculations. Weather and renewable forecasting data within the external data inputs 76 includes solar irradiance predictions, wind speed forecasts, and weather pattern analysis affecting renewable energy availability and system planning. Energy market conditions data transmitted through the external data inputs 76 encompasses spot market pricing, virtual power plant participation opportunities, and energy arbitrage information enabling revenue generation protocols. Grid status information within the external data inputs 76 includes grid stability indicators, demand response signals, and utility communication data affecting grid interaction decisions.

User input signals 78 flow from user 60 through the user interface 56 to the cloud-based telemetry system 48. The user input signals 78 include protocol preference selections enabling the user 60 to choose between cost optimization protocols, renewable maximization protocols, storage maximization protocols, and revenue maximization protocols based on current objectives and priorities. Operational override commands within the user input signals 78 allow user 60 to suspend automated operation or manually control specific system functions when circumstances require direct intervention. Configuration parameters transmitted through the user input signals 78 include user-defined operational limits, performance targets, and system preferences that guide automated decision-making processes.

Central processing functions 80 within the cloud-based telemetry system 48 analyze and integrate information from upward data flows 74, external data inputs 76, and user input signals 78. The central processing functions 80 execute data fusion algorithms that combine real-time generator data with external information sources to create comprehensive operational intelligence. Optimization calculation engines within the central processing functions 80 execute mathematical algorithms that determine optimal energy source selections, storage management strategies, and operational parameters based on economic and performance criteria established by the selected protocols. Decision logic processors within the central processing functions 80 implement protocol-specific logic that translates high-level user preferences into specific operational commands suitable for transmission to the control system 36.

Downward command flows 82 transmit operational instructions from the cloud-based telemetry system 48 to the control system 36. The downward command flows 82 include energy source selection commands that specify which combination of renewable power source 12, grid power source 14, or stored energy can supply the load 34 at any given time based on optimization calculations. Storage management directives within the downward command flows 82 control charging and discharging of energy storage device 22 and hydrogen production by electrolyzer 20 according to selected protocol requirements and current system conditions. Grid interaction controls transmitted through the downward command flows 82 manage synchronization with grid power source 14 and energy export operations when revenue generation protocols are active. Operational parameter adjustments within the downward command flows 82 optimize system efficiency and performance based on current conditions and selected protocols.

Real-time feedback loops 84 provide continuous information exchange between the control system 36 and cloud-based telemetry system 48. The real-time feedback loops 84 enable immediate response to changing conditions and continuous optimization of system performance by confirming command execution, reporting system responses, and providing performance validation measurements. The real-time feedback loops 84 ensure that the central processing functions 80 receive current information necessary for accurate decision-making and protocol implementation.

FIG. 3 also demonstrates the comprehensive information architecture that enables autonomous operation of the zero-emission generator 11 system while maintaining user control and oversight capabilities. The bidirectional information flows and central processing functions 80 provide the intelligence necessary for optimal energy management based on real-time conditions, external data sources, and user preferences transmitted through the various signal pathways illustrated in the diagram.

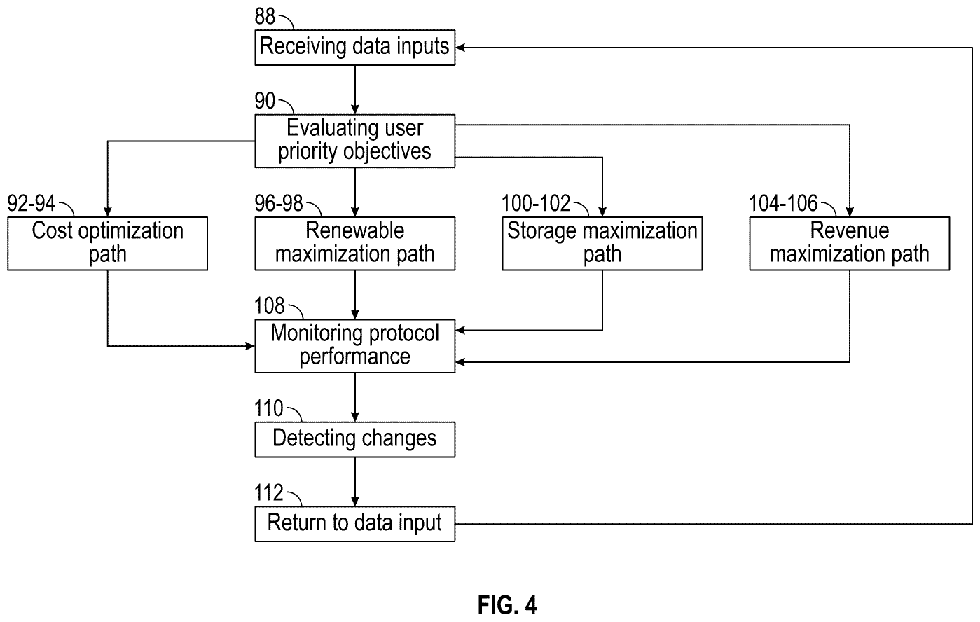

FIG. 4 illustrates method steps for autonomous protocol selection within the cloud-based telemetry access system. The method begins with receiving data inputs 88 from telemetry, external sources, and user preferences collected through the various data pathways. Evaluating user priority objectives 90 determines the primary operational goal selected through the user interface 56.

When cost optimization is the primary objective, comparing grid electricity costs against stored energy costs 92 uses current utility pricing data. Executing cost optimization protocol 94 occurs when grid costs exceed stored energy costs, while executing renewable maximization protocol 96 occurs when stored costs exceed grid costs. When environmental objectives take priority, assessing renewable energy availability 98 determines source selection, with executing renewable maximization protocol 96 when renewable sources are highly available, or executing storage maximization protocol 100 when renewable availability is low.

For storage-focused operations, checking current storage capacity levels 102 guides protocol selection, with executing storage maximization protocol 100 when storage levels are below target, or executing revenue maximization protocol 104 when storage exceeds capacity targets. When revenue generation is the priority, evaluating market pricing conditions 106 determines feasibility, leading to executing revenue maximization protocol 104 when market conditions are favorable. Following protocol execution, monitoring protocol performance and system response 108 provides feedback, while detecting changes in operational conditions or market factors 110 triggers protocol reevaluation, and returning to data input reception 112 when conditions change requiring protocol reassessment.

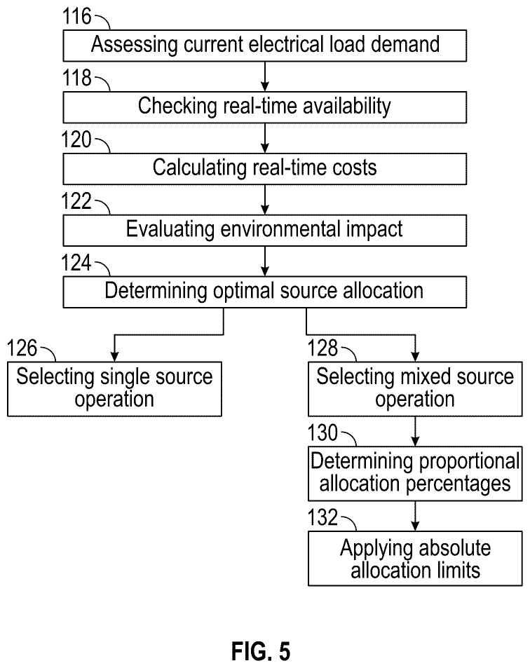

FIGS. 1, 2, and 5 illustrate an energy source selection logic flowchart showing method steps for real-time energy source selection within the central processing functions 80. The energy source selection process begins with assessing current electrical load demand 116 from load 34 to determine power requirements. Checking real-time availability 118 of renewable power source 12, grid power source 14, hydrogen fuel cell module 30, and energy storage device 22 establishes available capacity.

Calculating real-time costs 120 for electricity from each available source includes time-of-day pricing, operational costs, and opportunity costs. Evaluating environmental impact 122 of each energy source considers carbon intensity and renewable production levels. Determining optimal source allocation 124 combines cost analysis, environmental impact, and user protocol preferences.

When single source operation is optimal, selecting single source operation 126 supplies load 34 entirely from one source. When multiple sources provide better optimization, selecting mixed source operation 128 enables multiple source coordination. Determining proportional allocation percentages 130 establishes contribution levels for each participating source, while applying absolute allocation limits 132 establishes maximum power contributions in priority sequence.

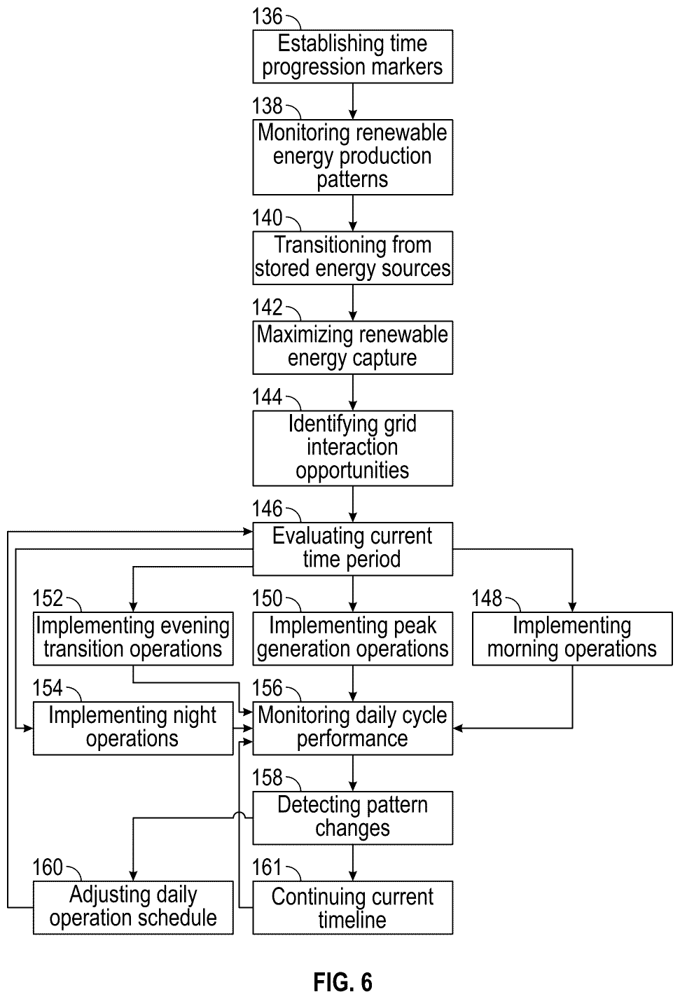

FIGS. 1, 2, and 6 illustrate an operational timeline diagram showing method steps for managing zero-emission generator operations throughout a 24-hour cycle. The method begins with establishing time progression markers 136 from 00:00 to 24:00 hours to track system operations. Monitoring renewable energy production patterns 138 tracks solar irradiance and wind conditions throughout the daily cycle.

The system continues with transitioning from stored energy sources 140 as renewable power source 12 becomes available with increasing solar irradiance. Maximizing renewable energy capture 142 directs excess production to electrolyzer 20 and energy storage device 22 during peak generation periods. Identifying grid interaction opportunities 144 determines optimal times for energy export based on favorable utility rates.

Evaluating current time period 146 determines which operational mode to implement based on renewable availability and load requirements. Implementing morning operations 148 occurs during sunrise periods when renewable sources begin production. Implementing peak generation operations 150 manages maximum renewable capture and energy storage during midday hours. Implementing evening transition operations 152 coordinates the shift from renewable to stored energy sources. Implementing night operations 154 maintains load supply using hydrogen fuel cell module 30 and energy storage device 22.

Following operational implementation, monitoring daily cycle performance 156 tracks system efficiency and protocol effectiveness throughout the 24-hour period. Detecting pattern changes 158 identifies variations in renewable production, load demand, or market conditions that require schedule adjustments. When changes are detected, adjusting daily operation schedule 160 modifies operational timing and protocol selection. When no changes are required, continuing current timeline 161 maintains established operational patterns for optimal system performance.

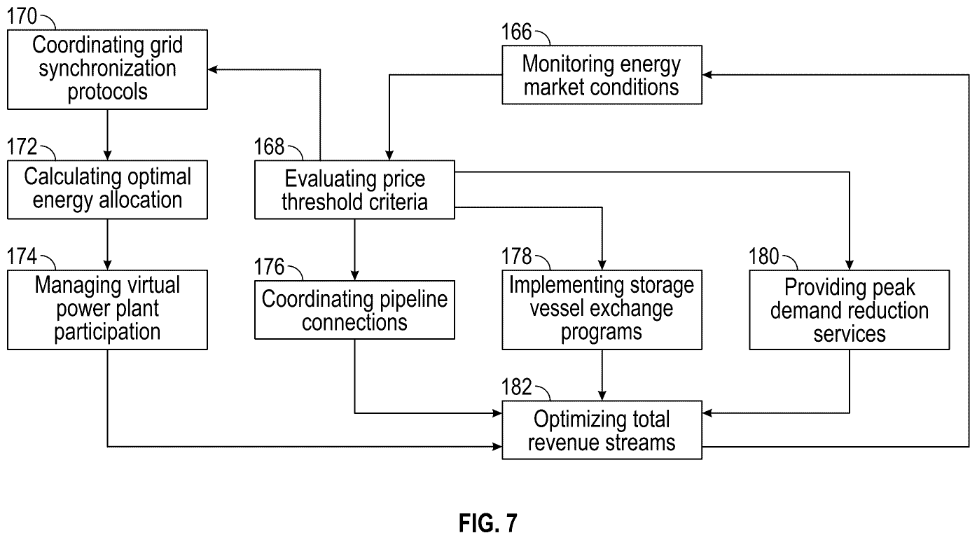

FIGS. 1, 2, and 7 illustrate a revenue generation process flow showing method steps for creating revenue streams through intelligent market participation. The revenue generation process begins with monitoring energy market conditions 166 to track spot electricity pricing, virtual power plant opportunities, and hydrogen market rates. Evaluating price threshold criteria 168 determines when market conditions exceed predetermined profitability levels that justify energy sales.

When electricity sales are favorable, coordinating grid synchronization protocols 170 ensures proper voltage, frequency, and phase alignment for power export to grid power source 14. Calculating optimal energy allocation 172 determines whether to sell electrical energy directly or convert hydrogen to electricity based on current market pricing. Managing virtual power plant participation 174 coordinates with grid operators for demand response and ancillary services.

For hydrogen sales opportunities, coordinating pipeline connections 176 manages direct hydrogen sales through distribution networks. Implementing storage vessel exchange programs 178 enables hydrogen sales through portable tank swapping arrangements. Providing peak demand reduction services 180 generates revenue by supplementing grid power during high-demand periods. Optimizing total revenue streams 182 balances energy sales, demand reduction services, and market participation while maintaining adequate reserves for load 34 requirements.

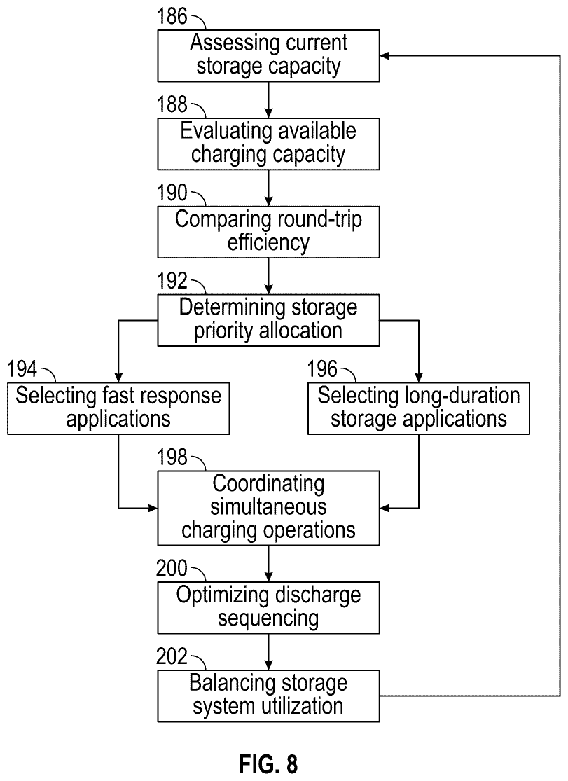

FIGS. 1, 2, and 8 illustrate a storage management decision process showing method steps for coordinating electrical and chemical energy storage systems. The storage management process begins with assessing current storage capacity 186 in both energy storage device 22 and hydrogen storage tank 26. Evaluating available charging capacity 188 determines additional energy storage potential based on physical limitations and safe operating parameters.

When excess renewable energy is available, comparing round-trip efficiency 190 calculates energy losses for electrical storage versus hydrogen production pathways. Determining storage priority allocation 192 decides whether excess energy can charge the energy storage device 22 directly or power the electrolyzer 20 for hydrogen production. Selecting fast response applications 194 favors electrical storage for immediate load balancing and grid support services.

For extended storage requirements, selecting long-duration storage applications 196 favors hydrogen production through electrolyzer 20 for multi-day or seasonal energy storage. Coordinating simultaneous charging operations 198 manages both electrical and chemical storage systems when sufficient excess energy is available. Optimizing discharge sequencing 200 determines the most efficient order for utilizing stored energy based on current load requirements and market conditions. Balancing storage system utilization 202 maintains optimal charge levels across both storage modalities to ensure system reliability and operational flexibility.

### C. Exemplary Telecommunications Networks

Some of the embodiments of the present disclosure may be utilized upon any telecommunications network capable of transmitting data including voice data and other types of electronic data. Examples of suitable telecommunications networks for some of the embodiments of the present disclosure include but are not limited to global computer networks (e.g. Internet), wireless networks, cellular networks, satellite communications networks, cable communication networks (via a cable modem), microwave communications network, local area networks (LAN), wide area networks (WAN), campus area networks (CAN), metropolitan-area networks (MAN), and home area networks (HAN). Some of the example embodiments of the present disclosure may communicate via a single telecommunications network or multiple telecommunications networks concurrently. Various protocols may be utilized by the electronic devices for communications such as but not limited to HTTP, SMTP, FTP and WAP (wireless Application Protocol). Some of the embodiments of the present disclosure may be implemented upon various wireless networks such as but not limited to 3G, 4G, 5G, LTE, CDPD, CDMA, GSM, PDC, PHS, TDMA, FLEX, REFLEX, IDEN, TETRA, DECT, DATATAC, and MOBITEX. Some of the various example embodiments of the present disclosure may also be utilized with online services and internet service providers.

The Internet is an exemplary telecommunications network for the embodiments of the present disclosure. The Internet is comprised of a global computer network having a plurality of computer systems around the world that are in communication with one another. Via the Internet, the computer systems are able to transmit various types of data between one another. The communications between the computer systems may be accomplished via various methods such as but not limited to wireless, Ethernet, cable, direct connection, telephone lines, and satellite.

### D. Central Communication Unit

The central communication unit may be comprised of any central communication site where communications are preferably established with. The central communication units may be comprised of a server computer, cloud based computer, virtual computer, home computer or other computer system capable of receiving and transmitting data via IP networks and the telecommunication networks. As can be appreciated, a modem or other communication device may be required between each of the central communication units and the corresponding telecommunication networks. The central communication unit may be comprised of any electronic system capable of receiving and transmitting information (e.g. voice data, computer data, etc.).

### E. Mobile Device

The mobile device may be comprised of any type of computer for practicing the various aspects of the embodiments of the present disclosure. For example, the mobile device can be a personal computer (e.g. APPLE® based computer, an IBM based computer, or compatible thereof) or tablet computer (e.g. IPAD®). The mobile device may also be comprised of various other electronic devices capable of sending and receiving electronic data including but not limited to smartphones, mobile phones, telephones, personal digital assistants (PDAs), mobile electronic devices, handheld wireless devices, two-way radios, smart phones, communicators, video viewing units, television units, television receivers, cable television receivers, pagers, communication devices, and digital satellite receiver units.

The mobile device may be comprised of any conventional computer. A conventional computer preferably includes a display screen (or monitor), a printer, a hard disk drive, a network interface, and a keyboard. A conventional computer also includes a microprocessor, a memory bus, random access memory (RAM), read only memory (ROM), a peripheral bus, and a keyboard controller. The microprocessor is a general-purpose digital processor that controls the operation of the computer. The microprocessor can be a single-chip processor or implemented with multiple components. Using instructions retrieved from memory, the microprocessor controls the reception and manipulations of input data and the output and display of data on output devices. The memory bus is utilized by the microprocessor to access the RAM and the ROM. RAM is used by microprocessor as a general storage area and as scratch-pad memory, and can also be used to store input data and processed data. ROM can be used to store instructions or program code followed by microprocessor as well as other data. A peripheral bus is used to access the input, output and storage devices used by the computer. In the described embodiments, these devices include a display screen, a printer device, a hard disk drive, and a network interface. A keyboard controller is used to receive input from the keyboard and send decoded symbols for each pressed key to microprocessor over bus. The keyboard is used by a user to input commands and other instructions to the computer system. Other types of user input devices can also be used in conjunction with the embodiments of the present disclosure. For example, pointing devices such as a computer mouse, a track ball, a stylus, or a tablet to manipulate a pointer on a screen of the computer system. The display screen is an output device that displays images of data provided by the microprocessor via the peripheral bus or provided by other components in the computer. The printer device when operating as a printer provides an image on a sheet of paper or a similar surface. The hard disk drive can be utilized to store various types of data. The microprocessor, together with an operating system, operates to execute computer code and produce and use data. The computer code and data may reside on RAM, ROM, or hard disk drive. The computer code and data can also reside on a removable program medium and loaded or installed onto computer system when needed. Removable program mediums include, for example, CD-ROM, PC-CARD, USB drives, floppy disk and magnetic tape. The network interface circuit is utilized to send and receive data over a network connected to other computer systems. An interface card or similar device and appropriate software implemented by microprocessor can be utilized to connect the computer system to an existing network and transfer data according to standard protocols.

Any and all headings are for convenience only and have no limiting effect. Unless otherwise defined, all technical and scientific terms used herein have the same meaning as commonly understood by one of ordinary skill in the art to which this invention belongs. Although specific terms are employed herein, they are used in a generic and descriptive sense only and not for purposes of limitation. All patent applications, patents, and printed publications cited herein are incorporated herein by reference in their entireties, except for any definitions, subject matter disclaimers or disavowals, and except to the extent that the incorporated material is inconsistent with the express disclosure herein, in which case the language in this disclosure controls.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs), DVDs (digital video discs), and computer instruction signals embodied in a transmission medium (with or without a carrier wave upon which the signals are modulated). For example, the transmission medium may include a telecommunications network, such as the Internet.

It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention. These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer usable medium having a computer-readable program code or program instructions embodied therein, the computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks. Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

The present invention may be embodied in other specific forms without departing from the spirit or essential attributes thereof, and it is therefore desired that the present embodiment be considered in all respects as illustrative and not restrictive. Many modifications and other embodiments of the present disclosure will come to mind to one skilled in the art to which this invention pertains and having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although methods and materials similar to or equivalent to those described herein can be used in the practice or testing of the embodiments in the present disclosure, suitable methods and materials are described above. Thus, the present disclosure is not intended to be limited to the embodiments shown, but is to be accorded the widest scope consistent with the principles and features disclosed herein.

What is claimed is:

1. A system for managing performance protocols in a zero-emission electrical generator, the system comprising:
a zero-emission generator comprising a hydrogen fuel cell module, an electrolyzer, a hydrogen storage tank, an energy storage device, and an inverter configured to receive power from a plurality of energy sources including grid power, renewable power sources, and power from the hydrogen fuel cell module;
a cloud-based telemetry system comprising a processor and memory, the cloud-based telemetry system configured to store a plurality of user-selectable performance management protocols, each performance management protocol defining operational parameters for generator performance according to different objectives;
a user interface operatively connected to the cloud-based telemetry system and configured to receive user inputs;
a communication interface configured to establish bidirectional communication between the zero-emission generator and the cloud-based telemetry system;
the cloud-based telemetry system configured to:
receive real-time operational data from the zero-emission generator via the communication interface;
receive a protocol selection input from the user interface and identify a corresponding performance management protocol from the plurality of user-selectable performance management protocols;
automatically generate control commands based on the corresponding performance management protocol and the real-time operational data; and
transmit the control commands to the zero-emission generator via the communication interface to automatically control energy source selection and proportioning without manual user intervention at the generator.

2. The system of claim 1, wherein the plurality of user-selectable performance management protocols comprising a lowest cost protocol configured to minimize operational costs by selecting energy sources based on real-time cost comparisons between grid electricity, energy stored in the energy storage device, and energy stored in the hydrogen storage tank.

3. The system of claim 1, wherein the plurality of user-selectable performance management protocols comprising a maximum renewable protocol configured to prioritize renewable energy sources and redirect renewable energy exceeding load demand to the energy storage device and the hydrogen storage tank.

4. The system of claim 1, wherein the plurality of user-selectable performance management protocols comprising a maximum storage protocol configured to charge the energy storage device and the hydrogen storage tank to their respective storage capacities.

5. The system of claim 1, wherein the plurality of user-selectable performance management protocols comprising a maximum revenue protocol configured to sell stored electrical energy and stored hydrogen based on market pricing data.

6. The system of claim 1, wherein the cloud-based telemetry system configured to receive grid pricing data comprising time-of-day rates, demand charges, and peak usage charges for use in generating the control commands.

7. The system of claim 1, wherein the control commands comprising proportional allocation commands specifying percentages of power to be delivered from each of the plurality of energy sources.

8. The system of claim 1, wherein the control commands comprising absolute allocation commands specifying maximum power amounts to be delivered from each of the plurality of energy sources.

9. The system of claim 1, wherein the zero-emission generator further comprising a compressor configured to compress hydrogen from the electrolyzer for storage in the hydrogen storage tank.

10. A method of operating a zero-emission electrical generator having a plurality of energy sources, the method comprising:
establishing communication between the zero-emission generator and a cloud-based telemetry system;
uploading real-time operational data from the zero-emission generator to the cloud-based telemetry system, the operational data including power generation levels, storage levels, and energy consumption data;
receiving a user selection of a performance management protocol from a plurality of available protocols stored in the cloud-based telemetry system, each protocol defining different objectives for generator operation;
automatically determining energy source allocation based on the performance management protocol corresponding to the user selection and the real-time operational data; generating control commands corresponding to the energy source allocation; and
transmitting the control commands from the cloud-based telemetry system to the zero-emission generator to automatically control energy distribution from the plurality of energy sources comprising grid power, renewable power sources, and hydrogen fuel cell power.

11. The method of claim 10, wherein determining energy source allocation comprises comparing real-time costs of grid electricity with calculated costs of generating electricity from stored hydrogen and electrical energy stored in the energy storage device.

12. The method of claim 10, wherein the performance management protocol comprises a lowest cost protocol, and determining energy source allocation comprises selecting renewable energy sources when available at no cost and comparing costs of energy from storage devices with grid electricity costs.

13. The method of claim 10, wherein the performance management protocol comprises a carbon footprint minimization protocol, and determining energy source allocation comprises prioritizing renewable energy sources and selecting between grid power and stored energy based on carbon emissions data for each energy source.

14. The method of claim 10, further comprising storing renewable energy exceeding load demand by directing surplus renewable power to the electrolyzer for hydrogen production or to the energy storage device.

15. The method of claim 10, wherein the control commands comprising instructions for proportional power distribution specifying percentages of total load demand to be satisfied by each energy source.

16. A method of managing performance protocols for zero-emission electrical generators, the method comprising:
storing a plurality of performance management protocols in a cloud-based telemetry system, each protocol comprising operational parameters for achieving different performance objectives;
providing a user interface operatively connected to the cloud-based telemetry system for selecting from the plurality of performance management protocols;
receiving real-time data from a zero-emission generator comprising hydrogen production rates, hydrogen storage levels, electrical storage levels, renewable energy availability, and grid power costs;
processing the real-time data in combination with a selected performance management protocol to determine operational settings for the zero-emission generator;
automatically generating control signals based on the operational settings; and
transmitting the control signals to the zero-emission generator to implement automatic energy source management according to the selected performance management protocol.

17. The method of claim 16, wherein the plurality of performance management protocols comprises a maximum storage protocol configured to simultaneously charge energy storage devices and produce hydrogen for storage when renewable energy exceeds load demand.

18. The method of claim 16, wherein the processing comprises accessing external data sources including real-time electricity pricing, renewable energy forecasts, and market pricing for stored energy products.

19. The method of claim 16, wherein the operational settings comprises energy source priorities, storage charging rates, and load distribution ratios among a plurality of energy sources.

20. The method of claim 16, further comprising monitoring performance of the selected performance management protocol and automatically adjusting the operational parameters based on measured performance metrics.
